(19) United States
(12) Patent Application Publication
(10) Pub. No.: US 2019/0255698 A1
(43) Pub. Date: Aug. 22, 2019

(54) APPARATUS FOR HANDLING ARTICLES

(71) Applicant: KRONES Aktiengesellschaft, Neutraubling (DE)

(72) Inventors: Peter ZEINER, Raubling (DE); Alexander HARTUNG, Rohrdorf (DE); Stefan ELSPERGER, Soechtenau (DE); Heiner SCHAEFER, München (DE); Torsten KILGENSTEIN, Neumarkt (DE); Konrad SENN, Alteglofsheim (DE)

(21) Appl. No.: 16/310,093

(22) PCT Filed: May 24, 2017
(86) PCT No.: PCT/EP2017/062536

§ 371 Date: Dec. 14, 2018

(30) Foreign Application Priority Data
Jun. 22, 2016 (DE) 10 2016 211 169.8

(51) Int. Cl. B25J 5/02; B25J 9/00; B65B 21/18

(52) U.S. Cl. CPC B25J 5/02; B65B 21/183; B25J 9/0036

(57) ABSTRACT

Described is an apparatus (01) for handling articles, which apparatus (01) comprises at least one group (04; 05; 06; 07; 08) consisting of a carriage pair (40; 50; 60; 70; 80) of two carriages (41, 42; 51, 52; 61, 62; 71, 72; 81, 82) that are driven movable independently of one another along a closed circulating guide track (03), which carriages (41, 42; 51, 52; 61, 62; 71, 72; 81, 82) are interconnected by means of a linkage (43; 53; 63; 73) with a central coupling element (44; 54; 64; 74) as well as by means of two linkage elements (45; 55; 65; 75) that are in each instance articulately connected to the coupling element (44; 54; 64; 74) and to in each instance one of the carriages (41, 42; 51, 52; 61, 62; 71, 72; 81, 82).

### CLAIM OF PRIORITY

The present application claims priority to International Application PCT/EP2017/062536, filed May 24, 2017, which in turn claims priority to German Application DE 10 2016 211 169.8, filed Jun. 22, 2016, which are incorporated by reference.

### FIELD OF THE INVENTION

The present invention relates to an apparatus for handling articles, the apparatus having the features of the independent claim 1.

### BACKGROUND OF THE INVENTION

In automation technology, where a multitude of articles, for example of the same type, have to be handled, for example in automation technology for the food and beverage industry and/or in packaging technology and in the packaging industry, it is customary to provide apparatuses for handling articles that are specifically designed for repetitive procedures.

The articles can be objects, for example, such as packaged or unpackaged objects, containers, cartons, or they can be bundles of a plurality of objects where the objects of a bundle are held together, for example by a strapping, by an outer package, such as a wrapping, a shrink tube, or a box, or a carrying rack, to mention just a few conceivable embodiments.

An apparatus for handling articles is known from U.S. Pat. No. 4,257,727 A, where the handling provides the placement of bottles arriving standing upright and being transported by an overhead conveyor into beverage cases being delivered and removed by a lower conveyor. The apparatus comprises groups of gripper heads that continuously circulate along a closed circulating guide track. The guide track is formed by a traction means, to which the gripper heads are each individually fastened, and which is guided around deflection rollers. Special deflection rollers at neuralgic deflection positions act upon the gripper heads such that the gripper heads are always actuated alternatingly upon passing the neuralgic deflection positions, that is to say, they are closed at a first neuralgic deflection position, and reopened at a second neuralgic deflection position. Lifting and lowering movements of the gripper heads are specified by the course of the traction means, with the course representing a height profile of the guide track.

For the same purpose, an apparatus for handling articles is known from DE 196 28 563 A1, where the apparatus comprises groups of gripper heads that continuously circulate along a closed circulating guide track. A second, closed circulating curve track with locally variable spacing from the guide track controls the opening and closing of the gripper heads, which are lowered hereby and by their common movement along the guide track from above onto articles in the form of groups of bottles being supplied by a conveyor, grip and thereby hold the articles, take them along beyond the end of the conveyor, and dispose and release them into outer packages in the form of beverage cases positioned therebelow. The guide track and the curve track are each formed by own traction means that are guided around deflection rollers. The gripper heads are gathered together in groups and fastened at the traction means. The deflection rollers for the traction means of the guide track and for the traction means of the curve track have partly different positions in order to locally set a variable spacing. The traction means of the guide track and of the curve track are driven together synchronously.

A disadvantage of the known apparatuses is the high input in terms of construction and the low flexibility both in handling different articles and regarding different types of handling. This is caused by the fact that the particular height profile of each of the guide tracks of the apparatuses has to be precisely adapted to the procedure of the intended type of handling and to the height of the upright standing articles that are being handled. Even a slight change, for example in the height of the individual articles, cannot be mastered with suchlike apparatuses. Additional disadvantages arise from the necessity of an exact cycling of the speed of the article inflow, of the removal, and of the speed of all gripper heads as well as of the arrival of the gripper heads that take over the articles.

Another disadvantage results from the fact that suchlike apparatuses, which are also referred to as “packers”, can only handle article streams of articles being transported immediately following one another and contiguous to one another. This is caused by the gripper heads being intercoupled and being coupled non-variably spaced apart—as seen along the guide track—by the traction means. From this arises the necessity of producing an infeed of suitable article streams, which frequently involves the disadvantage that the articles have to be banked up first before they are gripped by the packer. It is no longer possible to subsequently achieve a continuous article flow in a facility comprising a corresponding apparatus.

Article handling apparatuses that are equipped with gripper heads or groups of gripper heads arranged at cam-controlled multi-bar linkage mechanisms have the mentioned disadvantages as well, since they also provide a synchronous circulation of all their gripper heads together with a, for example, central organ that is driven rotatably about an axis.

The object of the invention is to develop an apparatus for handling articles, where the design of the apparatus involves less complexity for being adapted to the article infeed, to the articles themselves, and to the handling to be carried out, and which apparatus can moreover be adapted to different handling types and/or different types of articles without requiring constructional changes.

The object is solved by the features of the independent claim. Advantageous embodiments are described in the claims, in the drawings, as well as in the following description, including the description relating to the drawings.

### SUMMARY OF THE INVENTION

The invention is accordingly realized by an apparatus for handling articles, which apparatus comprises at least one pair of two carriages that are driven movable independently of one another along a closed circulating guide track.

The carriage pair, consisting of two carriages that are driven movable independently of one another along the closed circulating guide track, is part of a group that, in addition to the carriage pair, comprises a linkage consisting of a central coupling element and two linkage elements articulately disposed on this coupling element.

The two carriages of the carriage pair of the group are connected to each other by the linkage of the group.

In each instance one carriage of the carriage pair of the group is articulately connected to a different one of the two linkage elements.

With a first end, each linkage element of the two linkage elements is articulately connected to the central coupling element; and with an in each instance remaining second end that is distant from the first end, each linkage element of the two linkage elements is articulately disposed on one of the two carriages.

At the same time, each of the two carriages of the carriage pair is articulately connected to exactly one of the two linkage elements.

The invention is accordingly realized by an apparatus for handling articles, which apparatus comprises at least one group consisting of a pair of two carriages driven movable independently of one another along a guide track, which carriages are interconnected by a linkage with a central coupling element, as well as by two linkage elements that are in each instance articulately connected to the coupling element and to in each instance one of the carriages.

The spacing between the central coupling element and the guide track is increased by a relative movement of the two carriages toward one another, whereas the spacing between the central coupling element and the guide track is reduced by a relative movement of the two carriages away from one another.

Since it is possible for each group, consisting of a pair of carriages interconnected with a linkage of a central coupling element and two linkage elements articulately disposed thereon, to circulate along the closed circulating guide track, each such group can be regarded as a circulating parallel kinematic robot, a plurality of which can be provided in the apparatus to be driven movable independently of one another along the common, closed circulating guide track.

A manipulator can be formed or disposed on the coupling element of each of the groups.

For example, the coupling element itself can form or comprise a manipulator, which, for example, pushes over articles, which are being transported by a first conveyor, onto a second conveyor. Provided that the two conveyors have different transport speeds, the manipulator can in this context provide both acceleration and tilt protection at the same time, for example for upright standing articles. With the circulation speed of the carriages being individually controllable, the carriages allow the independent movement and control of the individual groups for a plurality of groups circulating along the guide track.

Alternatively, a manipulator can be disposed on the coupling element, the manipulator taking, for example, the form of a gripper or of a gripper head comprising a plurality of grippers. Since a group can wait for a following article to arrive due to the individual control of the movement of the group's carriages along the guide track, the apparatus is able to handle articles arriving, for example, at least temporarily irregularly, by a corresponding manipulator being disposed on the coupling element of a group. In contrast to the prior art, the apparatus thus does not require an exact cycling of the circulation of the manipulators—designed for example as gripper heads—and of the arriving articles; nor does it require precise speed matching. An elaborate constructional solution is replaced by a sensor detection of arriving articles in combination with a thereby controlled movement of the carriage pair of a group along the guide track.

A transmission of control commands and/or of drive energy—for example by sliding contacts along the guide track, or contact-free, for example by radio technology or, in the instance of drive energy, for example by microwaves or induction—enables an individual actuation of the manipulator of each of the groups without having to constructionally design elaborate motion links for this purpose, as is necessary in the prior art.

At least in an operating range facing toward one or more work surfaces on which or between which a handling of articles takes place, the closed circulating guide track can trace a wave that follows, for example, a vertical movement of placing articles into outer packages. A coupling element coupled with a carriage pair circulating along such a closed circulating guide track thus traces the placing movement automatically without the relative spacing between the carriages of the carriage pair changing. The programming of control commands to coordinate the relative movements of the carriages of a carriage pair can hereby be simplified.

The carriages can circulate along a closed circulating guide track that spans a surface lying in a vertical plane.

Alternatively, the carriages can circulate along a closed circulating guide track that spans a surface running substantially horizontally.

It is obvious that the invention makes it possible to handle articles arriving in a continuous article stream while eliminating all disadvantages of the prior art. In particular, the invention can provide a continuous packing of continuously arriving articles designed as bottles into outer packages, for example beverage cases. In the prior art, the continuity of the arriving article stream first has to be interrupted by banking up the articles because the hitherto known apparatuses provided for suchlike handling are only able to handle articles that arrive immediately contiguous to one another or following one another uniformly spaced apart.

The apparatus according to the invention, by contrast, is able to handle articles arriving in any manner by the carriage pairs being individually movable along the guide track with the carriages being interconnected by a linkage with a central coupling element, in conjunction with a common movability of the carriages, as well as by an additional movability of the carriages relative to each other.

The apparatus thus allows the handling of articles arriving in a steady article stream, where the articles are transported by conveyors immediately contiguous to one another, following each other or rather one after another closely spaced, or where the articles are transported following each other or rather one after another at constant spaces relative to each other.

By the apparatus's carriage pairs being driven movable independently of one another along the guide track with the carriages being articulately interconnected variably spaced apart by a linkage with a central coupling element, the apparatus moreover allows the handling of articles arriving, for example, discontinuously and/or in an unsteady article stream, where the articles are transported by a conveyor following each other or rather one after another at least temporarily variably spaced apart.

A camera system, for example, or another optical system, such as an optical system including light barriers, can be advantageously used for detecting articles arriving in the apparatus.

The apparatus according to the invention thus enables the handling of articles without having to bank up the articles first, and thus greatly simplifies and downsizes the construction of a facility that is equipped with a corresponding apparatus for handling articles. The apparatus according to the invention in particular makes it possible for articles that have been treated by a facility equipped with a corresponding apparatus for handling articles, to be packed, for example continuously, in exactly the way they leave the previous treatment stations.

It is thus also obvious that the invention can be realized by an arrangement that, in addition to an apparatus as previously described and to be described in the following with the drawings: comprises a first transport device forming a first conveyor, which transport device provides an arriving article stream of articles that are being transported along a first transport track at a first transport speed following one another immediately and/or uniformly spaced apart and/or variably spaced apart; and comprises a second transport device forming a second conveyor, which transport device provides an arriving stream of outer packages of empty outer packages, for example bundles, portable cases, such as beverage cases, cartons or the like, that are being transported along a second transport track at a second transport speed following one another immediately and/or uniformly spaced apart and/or variably spaced apart, and which transport device—after the placement of the articles of the article stream has taken place without interruption of the transport movement and the outer packages have been filled by the apparatus—continues to transport the outer packages at the second transport speed in an outbound stream of outer packages.

In this instance, the first and the second transport speed by no means have to coincide, as is absolutely necessary in the prior art.

The advantages in comparison to the prior art include, among other things, that a required lifting movement is generated by a relative movement of the carriages of a carriage pair. This results in a variable packing curve with various release points.

An additional advantage results from the fact that no banking-up of the supplied articles has to take place prior to handling the articles because the apparatus is able to handle the individually arriving articles.

Further advantages result from a small number of carriage pairs provided with a linkage, which number is moreover variable depending on the required article turnover, which carriage pairs moreover circulate individually along the closed circulating guide track variably spaced apart corresponding to a variable division, so that the carriage pairs thereby allow the handling of articles arriving in any manner. This forms a contrast to a collectively fixed, coupled circulation in the prior art, for example, which requires constant spaces in conjunction with a preset, unchangeable synchronization.

Temporarily non-required groups, each comprising a carriage pair provided with a linkage, can be temporarily parked until being used again, for example, on storage tracks branching off from the closed circulating guide track.

### BRIEF DESCRIPTION OF THE FIGURES

In the following, the invention is explained in more detail by exemplary embodiments illustrated in the drawings. The size ratios of the individual elements in the figures do not necessarily reflect the real size ratios. It is to be understood that in some instances various aspects of the invention may be shown exaggerated or enlarged in relation to other elements to facilitate an understanding of the invention. The same or equivalent elements of the invention are designated using identical reference characters. Furthermore and for the sake of clarity, only the reference characters relevant for describing the individual figures are provided. It should be understood that the detailed description and specific examples, while indicating preferred embodiments, are intended for purposes of illustration only and are not intended to limit the scope of the invention. The schematic illustrations show as follows:

FIG. 1 shows a side view of a first exemplary embodiment of an arrangement comprising an apparatus for handling articles according to a first exemplary embodiment.

FIG. 2 shows a top view of a second exemplary embodiment of an arrangement comprising an apparatus for handling articles according to a first exemplary embodiment.

### DETAILED DESCRIPTION OF THE INVENTION

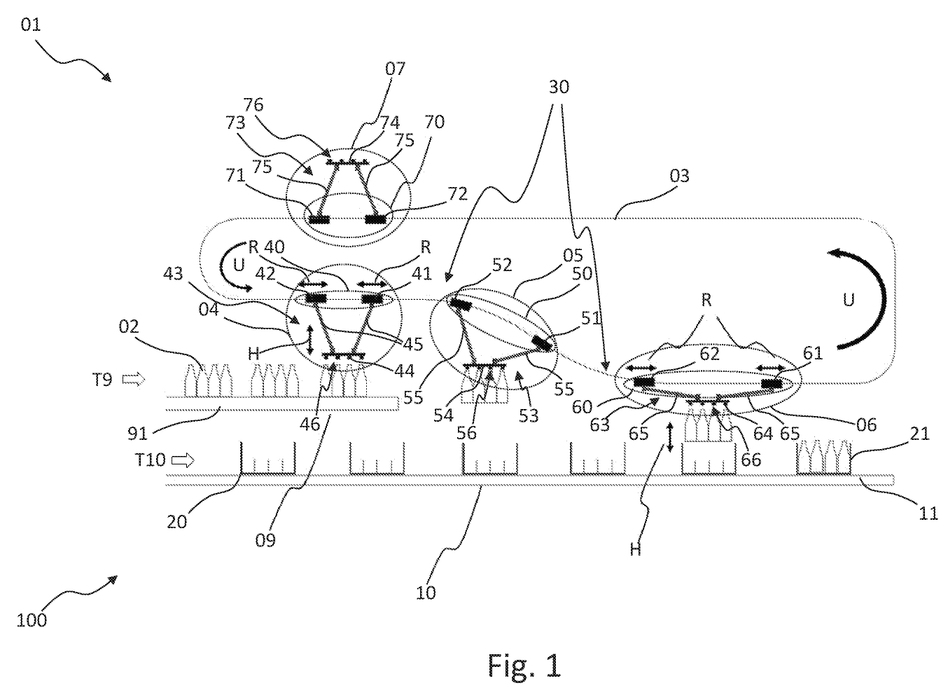

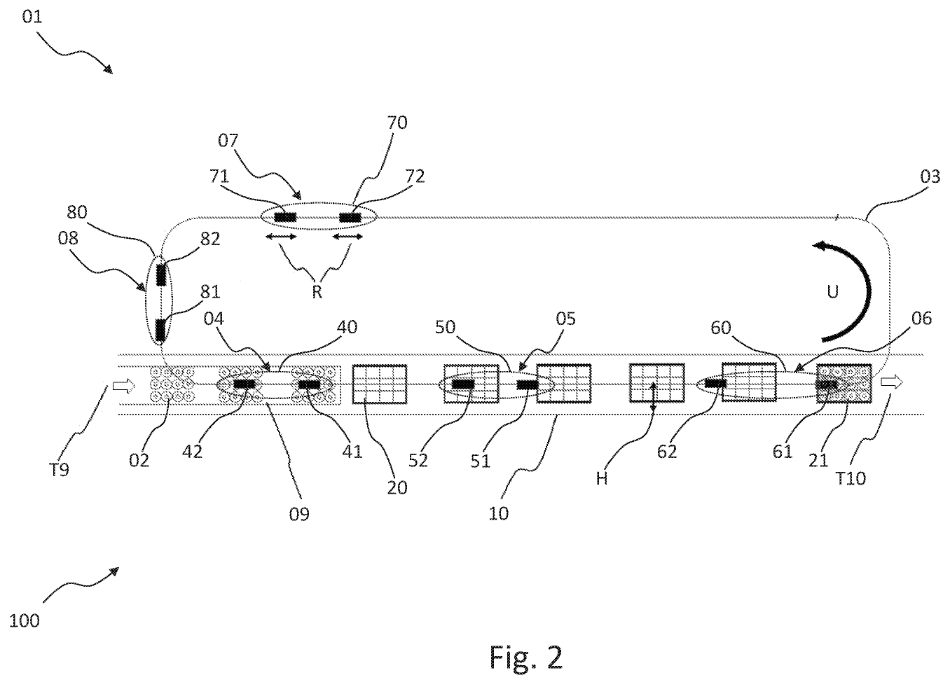

An apparatus 01 for handling articles 02, as illustrated completely or in parts in FIG. 1, FIG. 2, comprises:

a closed circulating guide track 03 and

at least one group 04; 05; 06; 07; 08, with:

a carriage pair 40; 50; 60; 70; 80 of two carriages 41, 42; 51, 52; 61, 62; 71, 72; 81, 82 that are driven movable independently from one another, both together and separately from one another, along the closed circulating guide track 03, and

a linkage 43; 53; 63; 73 connecting the carriages 41, 42; 51, 52; 61, 62; 71, 72; 81, 82 of the carriage pair 40; 50; 60; 70; 80 of the group 04; 05; 06; 07; 08 to each other, which linkage 43; 53; 63; 73 is designed toggle lever-type and/or with multiple links and which, for the purpose of clarity, is shown only in the side view in FIG. 1.

The carriages 41, 42; 51, 52; 61, 62; 71, 72; 81, 82 of the carriage pair 40; 50; 60; 70; 80 are interconnected within the particular group 04; 05; 06; 07; 08 by the toggle lever-type and/or multiple links-type linkage 43; 53; 63; 73, without the carriages 41, 42; 51, 52; 61, 62; 71, 72; 81, 82 of a carriage pair 40; 50; 60; 70; 80 in this context being fixated at a relative distance from another.

This is achieved by the linkage 43; 53; 63; 73 of each of the groups 04; 05; 06; 07; 08 being equipped with a central coupling element 44; 54; 64; 74 as well as with two linkage elements 45; 55; 65; 75 that are in each instance articulately connected to the central coupling element 44; 54; 64; 74 and to in each instance one of the carriages 41, 42; 51, 52; 61, 62; 71, 72; 81, 82 of the carriage pair of the group 04; 05; 06; 07; 08.

This makes it possible to drive the two carriages 41, 42; 51, 52; 61, 62; 71, 72; 81, 82 of each of the carriage pairs 40; 50; 60; 70; 80 separately from one another, so as to be movable independently of the carriage pairs 50; 60; 70; 80; 40 of further groups 05; 06; 07; 08; 04 together with each other as well as independently of the in each instance remaining carriage 41, 42; 51, 52; 61, 62; 71, 72; 81, 82 of the group 04; 05; 06; 07; 08, circulating together, and movable relative to each other along the guide track 03.

The apparatus 01 for handling articles 02 thus comprises at least one carriage pair 40; 50; 60; 70; 80 with two carriages 41, 42; 51, 52; 61, 62; 71, 72; 81, 82 that are driven movable independently of one another along a closed circulating guide track 03. The carriages 41, 42; 51, 52; 61, 62; 71, 72; 81, 82 of each of the carriage pairs 40; 50; 60; 70; 80 are connected to each other with the aid of a linkage 43; 53; 63; 73 comprising a central coupling element 44; 54; 64; 74 as well as two linkage elements 45; 55; 65; 75 articulately disposed thereon.

In each instance one carriage 41, 42; 51, 52; 61, 62; 71, 72; 81, 82 is articulately connected to a different one of the two linkage elements 45; 55; 65; 75.

With a first end, each linkage element 45; 55; 65; 75 of the two linkage elements 45; 55; 65; 75 of the linkage 43; 53; 63; 73 of a group 04; 05; 06; 07; 08 is articulately connected to the central coupling element 44; 54; 64; 74 of the group 04; 05; 06; 07; 08; and with an in each instance remaining second end that is distant from the first end, each linkage element 45; 55; 65; 75 is articulately disposed on one of the two carriages 41, 42; 51, 52; 61, 62; 71, 72; 81, 82 of the carriage pair 40; 50; 60; 70; 80 of the group 04; 05; 06; 07; 08.

In this context, each of the two carriages 41, 42; 51, 52; 61, 62; 71, 72; 81, 82 of the carriage pair 40; 50; 60; 70; 80 of the group 04; 05; 06; 07; 08 is articulately connected to exactly one of the two linkage elements 45; 55; 65; 75 of the linkage 43; 53; 63; 73 of the group 04; 05; 06; 07; 08.

It should be mentioned here that the articulated connections between the coupling element 44; 54; 64; 74 and the linkage elements 45; 55; 65; 75 in the linkage 43; 53; 63; 73 and between the linkage elements 45; 55; 65; 75 and the carriages 41, 42; 51, 52; 61, 62; 71, 72; 81, 82 on the linkage 43; 53; 63; 73 in each instance preferably have a kinematic degree of freedom about joint axes, which run parallel to each other. An increase and a reduction of the relative distance between the carriages 41, 42; 51, 52; 61, 62; 71, 72; 81, 82 of a carriage pair 40; 50; 60; 70; 80 of a group 04; 05; 06; 07; 08, which carriages 41, 42; 51, 52; 61, 62; 71, 72; 81, 82 are coupled by a linkage 43; 53; 63; 73, thus result in an exactly defined movement of the coupling element 44; 54; 64; 74.

It is important to point out in this context that the articulated connections between the linkage elements 45; 55; 65; 75 and the coupling element 44; 54; 64; 74 can comprise a common joint axis. At least within an operating range of the guide track 03, which operating range faces toward one or more work surfaces on which or between which a handling of articles 02 takes place, the work surfaces being formed, for example, by a section of a first transport device 09 and a section of a second transport device 10, the coupling element 44; 54; 64; 74 of a linkage can hereby, for example, be suspended, swinging damped or freely about this common joint axis, at the two linkage elements 45; 55; 65; 75 that are in each instance articulately disposed on one of the two carriages 41, 42; 51, 52; 61, 62; 71, 72; 81, 82 of a carriage pair 40; 50; 60; 70; 80 of the group 04; 05; 06; 07; 08 comprising the linkage 43; 53; 63; 73.

The apparatus 01 can be part of an arrangement 100 as illustrated completely or in parts in FIG. 1 or in FIG. 2. In addition to the apparatus 01, such an arrangement 100 can:

comprise a first transport device 09 forming a first conveyor, which transport device 09 provides an arriving article stream of articles 02 that are being transported along a first transport track 91 at a first transport speed, indicated in FIG. 1 and in FIG. 2 in each instance by an arrow T9, the articles 02 following one another immediately and/or uniformly spaced apart and/or variably spaced apart; and

comprise a second transport device 10 forming a second conveyor, which transport device 10 provides an arriving outer package stream of empty outer packages 20, for example bundles, portable cases, such as beverage cases, cartons or the like, that are being transported along a second transport track 11 at a second transport speed, indicated in FIG. 1 and in FIG. 2 in each instance by an arrow T10, the outer packages 20 following one another immediately and/or uniformly spaced apart and/or variably spaced apart, and which transport device 10—after the placement of the articles 02 of the article stream has taken place without interruption of the transport movement and the outer packages 21 have been filled by the apparatus 01—continues to transport the outer packages 21 at the second transport speed in an outbound outer package stream.

In the arrangement 100, the apparatus 01 provides a handling of articles comprising at least a transfer of the articles arriving with the article stream into the empty outer packages 20 arriving with the outer package stream.

The outer packages 21, initially empty and being filled after the placement of the articles 02 thereinto has taken place, are then uninterruptedly transported further on with the outer package stream.

In this instance, the first and the second transport speed by no means have to coincide, as is absolutely necessary in the prior art.

As already mentioned, the carriages 41, 42; 51, 52; 61, 62; 71, 72; 81, 82 of the carriage pair 40; 50; 60; 70; 80 of the at least one group 04; 05; 06; 07; 08 of the apparatus 01 are driven independently of one another, circulating in a common circulation direction, which is indicated in FIG. 1 and FIG. 2 by arrows U.

The independence of the circulation is characterized in that the spaces between the carriage pairs 40; 50; 60; 70; 80 of consecutive groups 04; 05; 06; 07; 08 can change during the circulation, for example repeatedly, in conjunction with variable circulation speeds of the carriage pairs 40; 50; 60; 70; 80 of the individual groups.

A group 04; 05; 06; 07; 08 can thereby be decelerated to a standstill, whereas another group 05; 06; 07; 08; 04 can at the same time be accelerated up to a design-dependent maximum speed. It is hereby for example possible to provision groups 04; 05; 06; 07; 08 in waiting positions, and then, upon the arrival of articles 02 transported by a first transport device 09 at a first transport speed as indicated by an arrow T9, to accelerate one or more groups to this first transport speed in order to take over the arriving articles 02, for example in a continuous manner, from the first transport device 09 without interruption of the transport movement of the first transport device 09 and also without changing the first transport speed. After the articles 02 have been taken over, the group 04; 05; 06; 07; 08 can deliver the articles 02 to a second transport device 10—operating, for example continuously, for example at a constant second transport speed as indicated by an arrow T10—for example by the group 04; 05; 06; 07; 08 placing and releasing the articles 02 taken over from the first transport device 09 into empty outer packages 20 transported by the second transport device 10. The independence of the circulation allows the first and the second transport speed to differ, although they could also be the same for another, for example greater, article throughput. By the independence of the circulation, the apparatus 01 is moreover able to handle articles 02 that arrive discontinuously—be this due to a temporal change of the first transport speed or due to variable spaces between articles 02 being consecutively transported by the first transport device 09. By the independence of the circulation, the apparatus 01 is in addition able to perform a handling of articles 02, where continuously or discontinuously arriving articles 20 are placed into continuously or discontinuously fed empty outer packages 20, independently of whether the discontinuity of the feed of empty outer packages 20 is caused by a temporal change of the second transport speed or caused by variable spaces between empty outer packages 20 being consecutively transported by the second transport device 10.

The carriages 41, 42; 51, 52; 61, 62; 71, 72; 81, 82 of each of the carriage pairs 40; 50; 60; 70; 80 are moreover driven movable independently of and thus separately from one another. Hereby, the carriages 41, 42; 51, 52; 61, 62; 71, 72; 81, 82 of each of the carriage pairs 40; 50; 60; 70; 80 are movable in relation to each other, as is indicated in FIG. 1 and FIG. 2 by double arrows R and by different spaces between the carriages 41, 42; 51, 52; 61, 62; 71, 72; 81, 82 of the carriage pairs 40; 50; 60; 70; 80 in different positions of groups 04; 05; 06; 07; 08 located along the guide track 03. The independence of the relative movability is characterized in that the carriages 41, 42; 51, 52; 61, 62; 71, 72; 81, 82 of each of the carriage pairs 40; 50; 60; 70; 80 can have, for example, repeatedly sectionwise different circulation speeds over the common circulation, whereby they have a relative speed in relation to each other, whereby a variable relative distance between the carriages 41, 42; 51, 52; 61, 62; 71, 72; 81, 82 of each of the carriage pairs 40; 50; 60; 70; 80 of a group 04; 05; 06; 07; 08 can be set at any position of the group 04; 05; 06; 07; 08 along the guide track 03.

In conjunction with the toggle lever-type, articulated linkage 43; 53; 63; 73 of a group 04; 05; 06; 07; 08, this makes it possible to perform, for example, a lifting and lowering movement of the central coupling element 44; 54; 64; 74 of the particular linkage 43; 53; 63; 73, as is indicated by double arrows H in FIG. 1 and FIG. 2.

The spacing between the central coupling element 44; 54; 64; 74 and the guide track 03 is increased by a relative movement of the two carriages 41, 42; 51, 52; 61, 62; 71, 72; 81, 82 of a carriage pair 40; 50; 60; 70; 80 toward one another, whereas the spacing between the central coupling element 44; 54; 64; 74 and the guide track 03 is reduced by a relative movement of the two carriages 41, 42; 51, 52; 61, 62; 71, 72; 81, 82 of a carriage pair 40; 50; 60; 70; 80 away from one another.

The common movement of the carriages 41, 42; 51, 52; 61, 62; 71, 72; 81, 82 of a carriage pair allows the synchronization with articles 02 arriving, for example, in a steady or unsteady article stream.

In contrast to a collectively fixed, coupled circulation in the prior art, for example, which requires constant spaces in conjunction with a preset, unchangeable synchronization of all components and variables—such as of the speed of the arriving articles with the speed of taking over and transferring the articles, as well as with the speed of the handling-effecting devices of an apparatus for handling the articles, of the relative positions of the arriving articles with the relative positions of the handling-effecting devices of the apparatus, as well as of the absolute positions of the arriving articles with the absolute positions of the handling-effecting devices of the apparatus—the apparatus 01 according to the invention makes it possible to handle articles 02 arriving in any manner. This is achieved thereby that, with a plurality of groups 04; 05; 06; 07; 08 driven movable along the closed circulating guide track 03—the groups 04; 05; 06; 07; 08 in each instance with a carriage pair 40; 50; 60; 70; 80 of carriages 41, 42; 51, 52; 61, 62; 71, 72; 81, 82 connected to each other, controllable individually and independently of one another in their common movement as well as in their relative movement by a linkage 43; 53; 63; 73 comprising a central coupling element 44; 54; 64; 74 as well as two linkage elements 45; 55; 65; 75 in each instance articulately disposed thereon and on in each instance one of the carriages 41, 42; 51, 52; 61, 62; 71, 72; 81, 82—the groups 04; 05; 06; 07; 08 circulate individually along the closed circulating guide track 03 variably spaced apart corresponding to a variable division.

A manipulator 46; 56; 66; 76 can be formed or disposed on the coupling element 44; 54; 64; 74 of each of the groups 04; 05; 06; 07; 08; or the coupling element 44; 54; 64; 74 can comprise a manipulator 46; 56; 66; 76 or the coupling element 44; 54; 64; 74 can be comprised by a manipulator 46; 56; 66; 76.

By a suitable design of the coupling element 44; 54; 64; 74 of the linkage 43; 53; 63; 73 of a group 04; 05; 06; 07; 08 as manipulator 46; 56; 66; 76, as well as by an arrangement of a correspondingly suitable manipulator 46; 56; 66; 76 on the coupling element 44; 54; 64; 74 of the linkage 43; 53; 63; 73 of a group 04; 05; 06; 07; 08, the apparatus 01 is able to handle, for example, at least temporarily irregularly arriving articles 02, because a group 04 can wait for a following article 02 to arrive due to the individual control of the common movement of the carriages 41, 42; 51, 52; 61, 62; 71, 72; 81, 82 of the group's carriage pair 40; 50; 60; 70; 80 along the guide track 03. In contrast to the prior art, the apparatus 01 thus does not require an exact cycling of the circulation of the manipulators 46; 56; 66; 76—designed as gripper heads, for example—and of the arriving articles 02, nor does it require precise speed matching. An elaborate constructional solution is replaced by a sensor detection of arriving articles 02 in combination with a thereby controlled movement of the carriage pair 40; 50; 60; 70; 80 of a group 04; 05; 06; 07; 08 along the guide track 03.

With the common circulation speed of the carriages 41, 42; 51, 52; 61, 62; 71, 72; 81, 82 of a carriage pair 40; 50; 60; 70; 80 being individually controllable, the carriages 41, 42; 51, 52; 61, 62; 71, 72; 81, 82 allow an independent movement and control of the individual groups 04; 05; 06; 07; 08 for a plurality of groups 04; 05; 06; 07; 08 circulating along the guide track 03. It is hereby possible to hold groups 04; 05; 06; 07; 08 in waiting positions until articles arrive for handling.

The carriage 41, 42; 51, 52; 61, 62; 71, 72; 81, 82 of each of the carriage pairs 40; 50; 60; 70; 80 are moreover individually controllable in their circulation speed separately from one another. By increasing the relative distance of the carriages 41, 42; 51, 52; 61, 62; 71, 72; 81, 82 of a carriage pair 40; 50; 60; 70; 80, the coupling element 44; 54; 64; 74 can thus be pulled closer to the guide track 03, whereas the coupling element 44; 54; 64; 74 is pushed further away from the guide track 03 by reducing the relative distance of the carriages 41, 42; 51, 52; 61, 62; 71, 72; 81, 82 of a carriage pair 40; 50; 60; 70; 80.

In this context, the coupling element 44; 54; 64; 74 itself can form or comprise a manipulator 46; 56; 66; 76, which, for example, pushes over articles 02 that are being transported by a first transport device 09 forming a first conveyor, onto a second transport device 10 forming a second conveyor. Provided that the two conveyors have different transport speeds, the manipulator 46; 56; 66; 76 can in this context serve to provide both acceleration and tilt protection at the same time, for example, for upright standing articles 02, such as bottles.

Alternatively, a manipulator 46; 56; 66; 76, for example in the form of a gripper or of a gripper head comprising a plurality of grippers, can be disposed on the coupling element 44; 54; 64; 74.

By a suitable design of the coupling element 44; 54; 64; 74 as manipulator 46; 56; 66; 76, as well as by an arrangement of a correspondingly suitable manipulator 46; 56; 66; 76 on the coupling element 44; 54; 64; 74, the apparatus 01 can be adapted to various handling types to be performed. The manipulator 46; 56; 66; 76 can be for example designed as an implement, such as a gripper, or as a contact surface.

The coupling element 44; 54; 64; 74 can in this instance serve as working platform, as the so-called tool center point (TCP). A previously described manipulator 46; 56; 66; 76 can be disposed on the TCP, or the TCP can comprise a previously described manipulator 46; 56; 66; 76, or the TCP can be comprised by a previously described manipulator 46; 56; 66; 76. Alternatively, the coupling element 44; 54; 64; 74 itself can form the manipulator 46; 56; 66; 76, with no motor drive of the manipulator 46; 56; 66; 76 being provided in this simple instance, but rather with a handling of an article 02 being carried out by the manipulator 46; 56; 66; 76 formed by the coupling element 44; 54; 64; 74 being brought into direct contact with the article 02 and shifting the article 02 on a work surface, for example.

The manipulator 46; 56; 66; 76 is positioned and moved, for example corresponding to an intended handling—such as a movement required for carrying out a manipulation and/or a transfer and/or a treatment of one or more articles 02—with the aid of a parallel kinematic robot of the apparatus 01 for handling articles 02 within a circulating working space specified by the course of the guide track 03 and limited by the maximally possible as well as the least possible spacing of the coupling element 44; 54; 64; 74 from the guide track 03, the parallel kinematic robot being formed by a group 04; 05; 06; 07; 08 comprising a carriage pair 40; 50; 60; 70; 80 of carriages 41, 42; 51, 52; 61, 62; 71, 72; 81, 82 that are driven independently of one another movable independently of one another at the closed circulating guide track 3 and by a linkage 43; 53; 63; 73 with two linkage elements 45; 55; 65; 75 articulately disposed in each instance with one of their ends on a central coupling element 44; 54; 64; 74 and each with a remaining end on in each instance one of the carriages.

At least one motor drive can be provided on the coupling element 44; 54; 64; 74 in order to actuate a manipulator 46; 56; 66; 76 disposed on the coupling element 44; 54; 64; 74 in the place within the working space where it was brought to by a parallel kinematic robot, and/or in order to twist the manipulator 46; 56; 66; 76 about a rotary axis standing, for example, vertically upright on the coupling element 44; 54; 64; 74, for example in order to perform a desired handling of articles and/or in order to align the manipulator 46; 56; 66; 76.

If the manipulator 46; 56; 66; 76 is for example supposed to be able to be twisted in relation to the coupling element 44; 54; 64; 74, it is possible that a drivably rotatable bearing of the manipulator 46; 56; 66; 76 is provided on the coupling element 44; 54; 64; 74, which bearing is connected, for example by a gearing mechanism or directly non-rotatably, to an output shaft of a motor drive disposed on the coupling element 44; 54; 64; 74.

If the manipulator 46; 56; 66; 76 disposed on the coupling element 44; 54; 64; 74 is to be alternatively or additionally actuated by at least one rotary movement of at least one output shaft of a motor drive disposed on the coupling element 44; 54; 64; 74 in order to perform one or more actions—for example in the instance of a manipulator 46; 56; 66; 76 being designed as a gripper for performing a gripping and releasing of one or more articles 02 corresponding to a closing and opening of a gripper—then the output shaft is connected to at least one corresponding input shaft of the manipulator 46; 56; 66; 76 or of a gearing mechanism of the manipulator 46; 56; 66; 76—for example in the instance of a manipulator 46; 56; 66; 76 being designed as a gripper with a traction means gearing mechanism converting rotary movements of the input shaft to linear movements of, for example, clamping jaws or gripping jaws of the gripper.

By a rotary movement generated by a motor drive provided on the coupling element 44; 54; 64; 74, it is in summary is possible to twist a manipulator 46; 56; 66; 76—provided, for example, on the coupling element 44; 54; 64; 74—about a rotary axis standing, for example, vertically upright on the coupling element 44; 54; 64; 74.

Alternatively or additionally, a rotary movement generated by a motor drive provided on the coupling element 44; 54; 64; 74 can be provided in order to actuate the manipulator 46; 56; 66; 76 so that it can perform an action, for example.

The manipulator 46; 56; 66; 76 can be, for example, a gripper or a gripper head comprising a plurality of grippers that can be closed and opened corresponding to a gripping and a releasing of one or more articles 02 by rotary movements in opposite directions, the movements being generated by a motor drive provided on the coupling element 44; 54; 64; 74. Between gripping and releasing, it is possible to carry out a transfer by movement of the corresponding group 04; 05; 06; 07; 08 of the apparatus 01 along the closed circulating guide track 03 or by an action of the manipulator in which the gripped articles 02 can be lifted up and relocated, for example.

With a manipulator 46; 56; 66; 76 designed, for example, as rotating finger, rotary movements generated by a motor drive provided on a coupling element 44; 54; 64; 74 can serve for aligning and/or transferring articles 02, for example by friction on a work surface where articles 02 are being handled.

With a manipulator 46; 56; 66; 76 provided and accordingly designed, for example, for the manipulation of articles 02, which are designed as containers, by removing or applying a screw top, for example, rotary movements generated by a motor drive provided on the coupling element 44; 54; 64; 74 can serve, for example, for loosening container lids—for example in recycling—or, for tightening container lids—for example in filling.

With a manipulator 46; 56; 66; 76 provided and accordingly designed, for example, for the treatment of articles 02, for example by applying a strapping around grouped articles, rotary movements generated by one or more motor drives provided on the coupling element 44; 54; 64; 74 can serve, for example, for cutting a strapping tape to length and/or for connecting, for example by crimping, the ends of the strapping tape to each other after wrapping the strapping tape around the articles. In this context, a number of motor drives, each generating rotary movements, can be provided on the coupling element 44; 54; 64; 74 corresponding to various required actions.

One or more linear drives can be alternatively provided, for example, in order to realize an opening and a closing of gripping jaws and/or a lifting and lowering of a gripper on the coupling element 44; 54; 64; 74.

The at least one rotary motor drive can be an electromotive rotary drive and/or an electrical rotary motor drive, for example.

In particular in the instance of a linear motor drive, this can be a pneumatic linear motor drive, for example.

A transmission of electric drive energy for the movement of the carriages 41, 42; 51, 52; 61, 62; 71, 72; 81, 82 along the guide track 03 and/or for the actuation of the manipulator formed or disposed on the coupling element 44; 54; 64; 74 can be carried out, for example, by sliding contacts running along the guide track 03, or contact-free, for example by microwaves or induction.

A transmission of control commands can be carried out, for example, by sliding contacts disposed along the guide track 03, or contact-free, for example by radio technology. This enables an individual actuation of the manipulator 46; 56; 66; 76 of each of the groups 04; 05; 06; 07; 08 without having to constructionally design elaborate motion links for this purpose, as is necessary in the prior art.

A contact-free electric energy supply, for example of at least one electric rotary motor drive and/or linear drive provided, for example, for the actuation of a manipulator 46; 56; 66; 76 on the coupling element 44; 54; 64; 74, can be provided by, for example, an inductive rail—also referable to as induction rail—running, for example, parallel to the closed, circulating guide track 03.

According hereto, an inductive rail running preferably parallel to the guide track 03 can be provided via which inductive rail the electric energy can be transmitted for driving one or more electric motor drives disposed on the coupling element 44; 54; 64; 74. Alternatively or additionally, the inductive rail can serve for the uni- or multilateral exchange of information, for example of control commands and/or sensor signals and/or feedback signals.

An energy supply for the actuation of the manipulator 46; 56; 66; 76 formed or disposed on the coupling element 44; 54; 64; 74 can alternatively comprise an energy storage device carried along by the group 04; 05; 06; 07; 08.

For example, a compressed air tank can be provided as energy storage device. A preferentially fast-charging electric storage is alternatively or additionally conceivable, for example a capacitor or an accumulator. This can provide both the energy required for the actuation of the manipulator 46; 56; 66; 76 and, alternatively or additionally, the energy required for control, for example for controlling valves of a compressed air control system.

In the instance of a energy storage device comprised by a group 04; 05; 06; 07; 08, the guide track 03 can comprise at least one charging point for the energy storage device. The charging point can be disposed, for example, along the closed circulating guide track 03, or on one of the storage tracks branching off from the closed circulation or forming a sectionwise parallel track.

The carriages 41, 42; 51, 52; 61, 62; 71, 72; 81, 82 of a carriage pair 40; 50; 60; 70; 80 that are individually controllable in their common circulation speed in this context allow an independent movement and control of the individual groups 04; 05; 06; 07; 08 of a plurality of groups 04; 05; 06; 07; 08 circulating along the guide track 03, which independent movement and control can be used for holding groups 04; 05; 06; 07; 08 in waiting positions, for example, in order to charge one or more energy storage devices for actuating a manipulator 46; 56; 66; 76, which energy storage devices are comprised by a group 04; 05; 06; 07; 08.

Independently of a recharge of a possibly provided energy storage device, a storage track allows equipping the apparatus 01 for handling articles 02 with a number of actively circulating groups 04; 05; 06; 07; 08 or parallel-kinematic robots, their number being variable depending on the required article turnover. Momentarily non-required groups 04; 05; 06; 07; 08 can be temporarily parked until being used again on one or more of the storage tracks branching off from the closed circulating guide track 03.

At least in an operating range facing toward one or more work surfaces on which or between which a handling of articles takes place, the closed circulating guide track 03 can have a wave 30 tracing a vertical movement of a group in the circulation, as is illustrated in FIG. 1. In this context, the guide track 03 can trace a wave 30 that follows, for example, a vertical movement of placing articles 02 into empty outer packages 20. A coupling element 44; 54; 64; 74 coupled with a carriage pair 40; 50; 60; 70; 80 circulating along such a closed circulating guide track 03 thus traces the placing movement automatically without the relative spacing between the carriages 41, 42; 51, 52; 61, 62; 71, 72; 81, 82 of the carriage pair 40; 50; 60; 70; 80 changing. The programming of control commands to coordinate the relative movements of the carriages 41, 42; 51, 52; 61, 62; 71, 72; 81, 82 of a carriage pair 40; 50; 60; 70; 80 can hereby be simplified.

As illustrated in FIG. 2, the closed circulating guide track 03 can span a surface lying in a vertical plane.

The carriages 41, 42; 51, 52; 61, 62; 71, 72; 81, 82 in this instance circulate along a closed circulating guide track 03 that spans a surface lying in a vertical plane.

Alternatively, the closed circulating guide track 03 can span a surface running substantially horizontally.

The carriages 41, 42; 51, 52; 61, 62; 71, 72; 81, 82 in this instance circulate along a closed circulating guide track 03 that spans a surface running substantially horizontally.

Hybrid forms of the two mentioned geometries of the surfaces spanned by the guide track 03 are generally also possible.

It is important to point out that the invention can be realized thereby that articles 02 in the form of bottles are placed into bundles by manipulators 46; 56; 66; 76 designed as grippers, the bundles replacing or forming the outer packages 20, during the continuous packing without previously banking up the bottles. The grippers are fastened to two carriages 41, 42; 51, 52; 61, 62; 71, 72; 81, 82 designed as long stator linear motor rotors. A stator bar of the linear motors—the stator bar forming the guide track 03—is located, at least with a section, above a container table formed or comprised by the first transport device 09, on which container table bottles are transported. Below the container table is a bundle track formed or comprised by the second transport device 10, on which the bundles are transported that replace or form the outer packages 20 which the bottles are placed into. Downstream from the container table, the course of the stator bar lowers to above the bundle track with the aid of cam elements of the stator bar. The grippers can be lifted and lowered by a relative movement of the rotors representing the carriages 41, 42; 51, 52; 61, 62; 71, 72; 81, 82. The two linear motors with the gripper move to above the container table and synchronize their collective forward movement with the bottles located on the container table, both in terms of speed and in terms of position along the guide track 03. The gripper head is lowered by the two carriages 41, 42; 51, 52; 61, 62; 71, 72; 81, 82—which are formed by the linear motor rotors—moving together relatively toward each other. It is thus possible to grip the bottles at different various points. A fixed receiving point for the bottles is not necessary. After the gripping of the bottles, the two carriages 41, 42; 51, 52; 61, 62; 71, 72; 81, 82 formed by the linear motor rotors move apart and the gripper head with the gripped bottles lifts up. During the entire gripping procedure, the group 04; 05; 06; 07; 08, in the present instance forming a system of linear motors and gripper head, moves at the same speed as the bottles on the container table. The gripped bottles then continue to move along above the bundle track and here synchronize their speed with the speed of the bundles. By the two carriages formed by linear motor rotors performing a movement relative to each other, the gripper head is again lowered, the bottles are delivered into the bundle, and the gripper head is lifted again. Here, again, the release point for the bottles is variable. The receiving points or the delivery points in the current prior art are by contrast non-variable and thus fixed. The system of linear motors and gripper head thereupon continues along the closed circulating guide track 03, which traces, for example, a circular path, and which is specified in its geometry by the course of the stator bar; and the system of linear motors and gripper head then waits in front of the container table for the next bottles. A plurality of groups 04; 05; 06; 07; 08, also referred to as systems of linear motors and gripper head, can be used on the stator bar.

The bottles can be gripped with the aid of manipulators 46; 56; 66; 76 that are designed as pneumatic gripper bells. For this purpose, a compressed air tank can be installed by energy storage onto the gripper head system corresponding to a group 04; 05; 06; 07; 08. The compressed air tanks can be filled at a fixed waiting position along the circulation of the guide track 03. In addition, the bottles can be gripped by purely mechanical grippers. In such an instance, an additional media supply for the gripper head system is no longer necessary. The size of the gripper head is variable. It is possible, for example, that a bottle row is gripped. In this instance, a plurality of bottle rows have to fill up the bundle with the aid of a plurality of gripper head systems, or all bottles that are needed for a bundle are gripped at once. It is possible to continuously pack vertically—in which instance the container table formed or comprised by the first transport device 09 is located above the bundle track formed by the second transport device 10—as well as horizontally—in which instance the container table formed or comprised by the first transport device 09 is located beside the bundle track formed by the second transport device 10.

It is likewise important to point out that an opening-closing movement, for example, or also a rotary movement of a manipulator 46, 56, 66, 76 disposed on the central coupling element 44; 54; 64; 74 of the particular carriage pair 40, 50, 60, 70, 80, can be initiated via an additional coupling linkage by a third carriage that can be moved relative to the carriages 41, 42; 51, 52; 61, 62; 71, 72; 81, 82 of a carriage pair 40, 50, 60, 70, 80; or an actuating movement—be it a rotary or a linear movement—required, for example, for opening and closing a gripper, can be correspondingly generated.

In this context it is generally conceivable to generate further movements by additional carriages, or to provide additional carriages for further movements, for example, of a manipulator 46, 56, 66, 76 disposed on the central coupling element 44; 54; 64; 74, which additional carriages are driven movable independently of one another and independently of the remaining carriages along the same closed circulating guide track 03.

The particular carriage pair 40, 50, 60, 70, 80 then forms a so-called master unit, in relation to which one or more carriages, in each instance forming a slave unit, are driven relatively movable along the same closed circulating guide track 03.

In that way it is possible to dispense with any further supply of other forms of energy for actuating a manipulator 46, 56, 66, 76 disposed on a central coupling element 44; 54; 64; 74.

In this context it should be additionally mentioned that the mechanical coupling for generating a movement is not limited to mechanical coupling linkages. A mechanical/pneumatic or a mechanical/hydraulic coupling by a piston rod acting upon a cylinder, for example, a hydraulic cylinder, is rather also conceivable. By a controlledly actuatable valve arrangement, a plurality of movements—for example, of a manipulator 46, 56, 66, 76 disposed on the central coupling element 44; 54; 64; 74—can be carried out independently of one another corresponding to a variable sequence of manipulations by only one slave unit.

It is generally also conceivable to generate electricity by magnetic induction by relative movements of a slave unit in relation to a master unit, which energy is then available on the master unit, for example for actuating a manipulator.

In conclusion, the previously used unified nomenclature is listed in the following table:

Apparatus 01=Guide track 03+One or more groups 04, 05, 06, 07, 08

Group 04, 05, 06, 07, 08=Carriage pair 40, 50, 60, 70, 80+Linkage 43; 53; 63; 73

Linkage 43; 53; 63; 73=Central coupling element 44; 54; 64; 74+Two linkage elements 45; 55; 65; 75 articulately disposed on the central coupling element 44; 54; 64; 74

Carriage pair 40, 50, 60, 70, 80=Two carriages 41, 42; 51, 52; 61, 62; 71, 72; 81, 82 driven movable independently of one another, circulating together, and movable relative to each other along the guide track 03.

Arrangement 100=Apparatus 01+First transport device 09 and second transport device 10

The apparatus 01 can alternatively or additionally have individual or a combination of a plurality of features initially described in connection with the prior art and/or in one or a plurality of documents mentioned regarding the prior art and/or in the above description and/or in the following claims.

The invention is not restricted by the description on the basis of the exemplary embodiments. Instead, the invention comprises every new feature as well as every combination of features, which in particular includes every combination of features in the claims, even if such claim or such combination is not itself explicitly taught in the claims or exemplary embodiments.

The invention is commercially applicable in particular in the field of the production and operation of facilities and apparatuses of automation technology, where a multitude of articles, for example of the same type, have to be handled, for example in automation technology for the food and beverage industry and/or in packaging technology and in the packaging industry.

The invention has been described with reference to a preferred embodiment. Those skilled in the art will appreciate that numerous changes and modifications can be made to the preferred embodiments of the invention and that such changes and modifications can be made without departing from the spirit of the invention. It is therefore intended that the appended claims cover all such equivalent variations as fall within the true spirit and scope of the invention.

### LIST OF REFERENCE CHARACTERS

01 Apparatus
02 Article
03 Guide track
04 Group
05 Group
06 Group
07 Group
08 Group
09 First transport device
10 Second transport device
11 Second transport track
20 Empty outer package
21 Filled outer package
30 Wave
40 Carriage pair
41 Carriage
42 Carriage
43 Linkage
44 Central coupling element
45 Linkage element
46 Manipulator
50 Carriage pair
51 Carriage
52 Carriage
53 Linkage
54 Central coupling element
55 Linkage element
56 Manipulator
60 Carriage pair
61 Carriage
62 Carriage
63 Linkage
64 Central coupling element
65 Linkage element
66 Manipulator
70 Carriage pair
71 Carriage
72 Carriage
73 Linkage
74 Central coupling element
75 Linkage element
76 Manipulator
80 Carriage pair
81 Carriage
82 Carriage
91 First transport track
100 Arrangement
R Double arrow (relative movability of the carriages of a carriage pair)
T9 Arrow (first transport speed)
T10 Arrow (second transport speed)
U Arrow (circulation direction)
H Double arrow (lifting and lowering movement of the coupling element)

1. An apparatus (01) for handling articles comprising:
at least one group (04; 05; 06; 07; 08) including of a carriage pair (40; 50; 60; 70; 80) of two carriages (41, 42; 51, 52; 61, 62; 71, 72; 81, 82) that are driven movable independently of one another along a closed circulating guide track (03), wherein the carriages (41, 42; 51, 52; 61, 62; 71, 72; 81, 82) are interconnected by a linkage (43; 53; 63; 73) with a central coupling element (44; 54; 64; 74) and by two linkage elements (45; 55; 65; 75) that are each articulately connected to the coupling element (44; 54; 64; 74) and to one of the carriages (41, 42; 51, 52; 61, 62; 71, 72; 81, 82).

2. The apparatus of claim 1, wherein the coupling element (44; 54; 64; 74) of each of the groups (04; 05; 06; 07; 08) comprises a manipulator (46; 56; 66; 76) or the manipulator (46; 56; 66; 76) is disposed on the coupling element (44; 54; 64; 74).

3. (canceled)

4. (canceled)

5. The apparatus claim 2, wherein at least one group (04; 05; 06; 07; 08) comprises at least one energy storage device.

6. The apparatus of claim 5, wherein the energy storage device comprises a compressed air tank.

7. The apparatus of claim 5, wherein the guide track (03) comprises at least one charging point for the energy storage device.

8. The apparatus of claim 5 further comprising a transmitter capable of transmitting energy to the manipulator (46; 56; 66; 76), either along the guide track (03) or contact-free.

9. The apparatus claim 5 further comprising a transmitter capable of transmitting control commands to the manipulator (46; 56; 66; 76), either along the guide track (03) or contact-free.

10. The apparatus of claim 5, wherein the guide track (03) comprises at least one storage track branching therefrom.

11. The apparatus claim 5, wherein the guide track (03) comprises a wave (30) that traces a vertical movement in the circulation of a group (04; 05; 06; 07; 08).

12. The apparatus of claim 5, wherein the guide track (03) spans a surface lying in a vertical plane.

13. The apparatus of claim 5, wherein the guide track (03) spans a surface running substantially horizontally.

14. A system (100) comprising:
an apparatus (01) comprising at least one group (04; 05; 06; 07; 08) including of a carriage pair (40; 50; 60; 70; 80) of two carriages (41, 42; 51, 52; 61, 62; 71, 72; 81, 82) that are driven movable independently of one another along a closed circulating guide track (03), wherein the carriages (41, 42; 51, 52; 61, 62; 71, 72; 81, 82) are interconnected by a linkage (43; 53; 63; 73) with a central coupling element (44; 54; 64; 74) and by two linkage elements (45; 55; 65; 75) that are each articulately connected to the coupling element (44; 54; 64; 74) and to one of the carriages (41, 42; 51, 52; 61, 62; 71, 72; 81, 82);
a first transport device (09) which provides an arriving article stream of articles (02) that are being transported along a first transport track (91) at a first transport speed (T9) following one another immediately and/or uniformly spaced apart and/or variably spaced apart; and
a second transport device (10), which provides an arriving outer package stream of empty outer packages (20) that are being transported along a second transport track (11) at a second transport speed (T10) following one another immediately and/or uniformly spaced apart and/or variably spaced apart, and which transport device (10) continues to transport the outer packages without interruption of the transport movement;
wherein the apparatus (01) provides a handling of articles (02) comprising at least a transfer of the articles (02) arriving with the article stream into the outer packages (20) arriving with the outer package stream.

15. A method of handling articles comprising:
transferring articles (02) arriving from an article stream into outer packages (20) arriving from an outer package stream, wherein the transferring step comprises:
transferring articles (02) with at least one group (04; 05; 06; 07; 08) including of a carriage pair (40; 50; 60; 70; 80) of two carriages (41, 42; 51, 52; 61, 62; 71, 72; 81, 82) that are driven movable independently of one another along a closed circulating guide track (03), wherein the carriages (41, 42; 51, 52; 61, 62; 71, 72; 81, 82) are interconnected by a linkage (43; 53; 63; 73) with a central coupling element (44; 54; 64; 74) and by two linkage elements (45; 55; 65; 75) that are each articulately connected to the coupling element (44; 54; 64; 74) and to one of the carriages (41, 42; 51, 52; 61, 62; 71, 72; 81, 82), wherein the coupling element (44; 54; 64; 74) comprises a manipulator (46; 56; 66; 76) or a manipulator (46; 56; 66; 76) is disposed on the coupling element (44; 54; 64; 74).

16. The method of claim 15 wherein the transferring step comprises vertically moving the coupling element (44; 54; 64; 74) from above the article stream to above the outer package stream while the at least one group (04; 05; 06; 07; 08) moves in a circulation direction (U) of the guide track (03).

17. The method of claim 15 wherein the transferring step comprises increasing or decreasing a distance between the two carriages (41, 42; 51, 52; 61, 62; 71, 72; 81, 82) of a particular carriage pair (40; 50; 60; 70; 80) while the at least one group (04; 05; 06; 07; 08) moves in a circulation direction (U) of the guide track (03).

18. The method of claim 17 further comprising:
moving the article stream on a first transport track (91) at a first transport speed (T9);
moving the package stream on a second transport track (11) at a second transport speed (T10).

19. The method of claim 15 further comprising supplying energy to the manipulator (46; 56; 66; 76) to operate mechanical movement of the manipulator (46; 56; 66; 76).

20. The method of claim 15 further comprising transmitting energy or control commands to the manipulator (46; 56; 66; 76), either along the guide track (03) or contact-free.

21. The system of claim 14 wherein the coupling element (44; 54; 64; 74) of each of the groups (04; 05; 06; 07; 08) comprises a manipulator (46; 56; 66; 76) or the manipulator (46; 56; 66; 76) is disposed on the coupling element (44; 54; 64; 74).
